(19) United States
(12) Patent Application Publication
(10) Pub. No.: US 2004/0018277 A1
(43) Pub. Date: Jan. 29, 2004

(54) Method for preparing frozen food products comprising a gelled aqueous phase

(76) Inventors: Philippe Zugmeyer, Saverne (FR); Martin Hovorka, Renarova (CZ); Sonia Roussel, Strasbourg (FR); Marc Baccus, Migneville (FR)

Correspondence Address: FITZPATRICK CELLA HARPER & SCINTO, 30 ROCKEFELLER PLAZA, NEW YORK, NY, 10112, US

(21) Appl. No.: 10/333,810

(22) PCT Filed: Jul. 27, 2001
(86) PCT No.: PCT/FR01/02473

(30) Foreign Application Priority Data
Jul. 27, 2000 (FR) 00/09848

(51) Int. Cl. A23G 9/00

(52) U.S. Cl. 426/101; 426/573

(57) ABSTRACT

The invention concerns a method for online preparation of frozen food products comprising a gelled aqueous phase. The method comprises a step A which consists in mixing the ingredients except for the gelling compound(s); a step B which consists in preparing a solution of gelling compounds then in dynamically mixing the compounds resulting from steps A and B; and finally in freezing said resulting product. The invention also concerns a frozen food product, in particular iced food products, obtainable by the method; the frozen food product has a soft, gelled, stable and homogeneous aqueous phase.

The invention relates to frozen food products, in particular ices, having a soft and chewy texture at the temperature for freezing food products (−5 to −30° C.).

The invention also relates to a method for preparing such food products.

Various types of gelatinous confectionery are known which incorporate a compound of the gelatin type, sometimes with another component, such as cream, jam, etc. The soft, resistant-to-chewing aspect constitutes one of the essential characteristics of the product, and is pleasing to the consumer.

For a long time, attempts have been made to develop frozen products having a gelled texture which confers on these frozen products a soft, chewy texture at the temperature for freezing food products (−5 to −30° C.). However, the current methods of preparation, and also the preparations which can be obtained using such methods, have shortcomings. The frozen products thus obtained have gelled phases which are unstable or which are not homogeneous; they also lose their chewiness at low temperature. These shortcomings generally become apparent during preparation, since gelling compounds such as gelatin or pectin set on contact with a frozen food compound or on contact with the surface of a cooled container.

An aim of the invention is therefore to provide a method for preparing frozen food products having a soft, gelled, stable and homogeneous aqueous phase. According to a preferred embodiment, the food product is an ice, and more particularly a sorbet, but the invention is also applicable to ice creams, to frozen yogurts, to iced custards, to water ices, to iced chocolate-flavored confectionery articles and in particular to iced chocolate-flavored bars and sticks.

With a view to realizing the invention, a method is provided, according to the invention, for online preparation of frozen food products comprising a gelled aqueous phase, which comprises various steps. Such a method comprises the steps of:

a) preparing a composition A obtained by mixing the ingredients, in an aqueous phase, with the exception of the gelling compound(s);

b) preparing a composition B obtained by dissolving at least one gelling compound and optionally some of the ingredients in water heated to a temperature above 40° C.;

c) continuously mixing said compositions A and B at a temperature of between 0° C. and 30° C.;

d) freezing said food product.

More particularly, the method of the invention comprises a first step which consists in preparing a composition A, which comprises the substeps of:

a)—mixing the ingredients, in an aqueous phase, with the exception of the gelling compound(s);

b)—optionally, pasteurizing the mixture obtained in a);

c)—maintaining the temperature of the mixture obtained in a) or b) in a tank at a temperature of between −5° C. and +15° C., preferably at +2° C. When it involves preparing a milk food product, the step of maintaining the temperature may include the step of maturation of the product.

Preparation A comprises at least one of the ingredients chosen from the group of sweetening agents, flavoring agents, taste enhancers, stabilizers, preservatives, dyes, and natural or artificial fruit concentrates. The various ingredients present in preparation A are determined by those skilled in the art depending on the gustative and energy-giving properties, and also on the appearance, that it is desired to confer on the product.

The sweetening agents may be of natural or artificial origin, and may, for example, be powdered sugar (sucrose), liquid sugar, glucose syrup, fructose and/or aspartame. The sweetening agent may be used in a proportion of 15 to 60% by weight of preparation A, preferably 20 to 40%. This proportion may be decreased when the sweetening agent is of artificial origin. In this case, it is advantageous to have a filling agent such as, for example, maltodextrin or polydextrose, to obtain the desired texture.

A variety of natural or artificial flavoring agents may also be used to make up the composition of preparation A. Thus, for example and in a nonlimiting manner, extracts of strawberry, of orange, of raspberry, of vanilla and/or cocoa may be used, depending on preference. The amount of flavoring agent is variable and depends on the desired gustative qualities. In general, the flavoring agent is present in a proportion ranging from 0.01 to 10% by weight of preparation A; it is preferably between 0.50 and 1.5%.

Among the stabilizers used, mention should be made of pectin, cellulose and methylcellulose. More particularly, the stabilizer may be gum, such as guar, carob, xanthan gum or acacia gum. These stabilizers also have gelling properties and may, in this respect, be introduced into the following preparation B.

Among the dyes which can be used, mention should in particular be made of elder and beta-carotene.

Among the preservatives which can be used for preparing the food product, mention should be made of glycerol and derivatives thereof. This agent has an additional value associated with its ability to attach water molecules. Specifically, this property of glycerol makes it possible to increase the transparency of the frozen gelatinous center when the glycerol is added to the aqueous phase during the preparation of the gelatinous center up to a concentration of 5% (beyond this, the glycerol gives the product an unpleasant taste).

The method comprises a second step of preparing a composition B, obtained by mixing the gelling compound(s) with an aqueous solution optionally containing some of the ingredients at a temperature of between +40° C. and +100° C., preferably between +60° C. and +90° C. This second step is carried out with agitation. Composition B is optionally kept in a tank with agitation at a temperature of between +40° C. and +100° C., preferably between +60° C. and +90° C. In addition, maintaining the temperature has the advantage of producing a batch pasteurization of composition B.

The third step of the method corresponds to the mixing of said compositions A and B at a temperature of between +5° C. and +20° C., preferably between +10° C. and +15° C.; this mixing is preferably carried out continuously. It is preferably of the dynamic type and is carried out using a dynamic mixer. The size of the rotor, the number of helices, the shape of the blades and also the rate of rotation of the rotor are adjusted by those skilled in the art as a function of the production volume, but also as a function of the texture, of the viscosity and, more generally, of the composition of the mixture of compositions A and B. Preferably, the dynamic mixer used is a high shear dynamic mixer, the rate of rotation of which is between 1 500 and 3 000 rpm.

Preferably, the method according to the invention comprises an additional step of bringing said food product obtained in the third step into contact with a second iced food product. In the context of preparing an ice, and in particular a sorbet, this second food product comprises an edible iced shell. The food product obtained in the third step corresponds to the gelled center of the sorbet; it has a gelled texture, i.e. a soft, chewy, stable and homogeneous texture. Preferably, the gelled center has a translucent appearance.

Finally, the last step of the method corresponds to the freezing of said food product obtained in the third or in the fourth step. This freezing is carried out at a temperature below 0° C., preferably between −20° C. and −30° C.

According to a preferred embodiment of the method according to the invention, said gelling compound is preferably chosen from the group composed of gelatin and pectin. More preferably, it is gelatin; this gelatin is present in the gelled center of the food product obtained in the third step of the method in a proportion ranging from 0.1 to 10%, preferably from 3 to 7%, by weight of the gelled center of said food product. The amount of gelling agent present in the food product depends on the type of product it is desired to obtain (i.e. the amount of aqueous phase, the consistency and the viscosity of the desired product, the influence of other components on the viscosity, the temperature of conservation and of consumption).

The food product obtained in the third step of the method may also comprise pectin in a proportion of 0.1 to 10%, preferably of 3 to 7%, by weight of the core of said food product.

However, other gelling compounds may be used; mention should be made of agar, guar, carob, alginates, xanthan gum, acacia gum.

The food product obtained in the third step of the method of the invention has a water content of between 30 and 70%, preferably between 40 and 60%, by weight of said food product obtained in the third step. The aqueous phase of the food product is introduced into the composition in the form of water in the preparation of sorbet, and may also be introduced in the form of milk. In the context of preparing ice cream, the milk corresponds either to natural milk, or to milk powder, lactoserum powder, lactose, or milk-proteins.

The preservative and the taste enhancer are preferably citric acid, which is present in said food product obtained in the third step of the method in a proportion ranging from 0.01% to 10%, preferably from 1 to 3%, by weight of said food product obtained in the third step.

Optionally, the method according to the invention also comprises one or more steps of preparing the edible shell.

The preparation of the edible shell is obtained by mixing various ingredients. The shell comprises at least one ingredient chosen from the group of water, sweetening agents, stabilizers, dyes, preservatives, taste enhancers, and fruit preparations. The shell may also comprise milk or chocolate.

The shell mixture is kept in a tank at +2° C., and then a measured amount of this mixture is poured into a mold. The mixture is then frozen; suction is applied to the center of the mould containing the mixture so as to leave on the sides of the mold only a fine film of frozen mixture corresponding to the shell.

This shell is kept frozen before being brought into contact, by filling, with the food product obtained in the third step of the method of the invention, i.e. the gelatinous center.

Finally, the present invention also relates to the frozen food product which can be obtained using the method.

The food product which can be obtained using the method of the invention may be any milk or nonmilk product, for example an ice cream, iced milk, iced custard, frozen yogurt, an iced mousse, a sorbet and a water ice, but also iced confectionery articles, in particular iced chocolate-flavored confectionery articles, such as iced chocolate-flavored bars or sticks. Preferably, the food product obtained using the method of the invention is selected from the group composed of ices. Among ices, it is more particularly a sorbet. When it is an ice, the method according to the invention may also comprise a step of inserting the stick into said ice and an additional step of removal from the mold. The step of inserting the stick uses the noteworthy texture of the gelled center, so as to insert the stick therein online; due to the texture of the center which is gelatinous at low temperatures, the stick remains in position, without falling, or without sinking into the sorbet.

The frozen food product which can be obtained using the method is characterized in that it has a soft, chewy texture at the temperature for freezing food products. This product is also stable, homogeneous and continuous.

According to the preferred embodiment of the invention, the sorbet has an edible shell which surrounds the gelatinous center obtained in the third step of the method and which has a soft and chewy structure. Preferably, the gelatinous center of the sorbet has a translucent appearance.

The method of preparation of the present invention can be easily set up in the food industry, in particular in the iced food products industry. The setting up thereof can be directly inserted into an already existing production line. This method can therefore be set up for a relatively small cost.

The food products which can be obtained using such a method, and in particular the ices, sorbets and chocolate-flavored bars, have a gelled texture and a translucent appearance which is pleasing to the public. They also have an obvious practical value since the gelled texture of the food product delays melting of the product, which may thus be consumed without the product running over the fingers of the consumer.

Other characteristics and advantages of the invention will become further apparent in the following description of a preferred embodiment of the invention, given by way of nonlimiting example.

According to a preferred mode, the method of the invention is used to prepare a sorbet on a stick. According to a preferred embodiment, composition A of the invention is obtained by mixing, in water, liquid sugar, glucose syrup, citric acid monohydrate, strawberry flavor, pectin (low methoxy content) and a red dye of the elder type. This composition is pasteurized and then placed under temperature maintenance in a tank at 2° C.

In parallel, or shifted in time, composition B of the invention is prepared. It corresponds to the preparation of an aqueous mixture of gelatin and pectin. These are dissolved in water heated to a temperature of 60° C. to 90° C., with agitation. Composition B is then stored in a tank with agitation at a temperature of between 60° C. and 90° C. Compositions A and B are then mixed with a high shear dynamic mixer. The mixture obtained constitutes the gelatinous center of the sorbet. The composition thereof is given in table I. The rate of rotation of the rotor is between 1 500 and 3 000 rpm, the temperature of the mixture A and B being between 10° C. and 15°.

In parallel, an edible shell is prepared according to a method already described in the prior art. The ingredients required in order to prepare the edible shell are given in table I. These ingredients are mixed in an aqueous phase. The frozen, molded edible shell is then filled online with the mixture of compositions A and B, at a temperature of between +10° C. and +15° C. The sorbet thus obtained is stored and frozen, and a stick is inserted online into its gelatinous center.

The sorbet is removed from the mold, stored and optionally packaged.

TABLE I

| | | Gelatinous | |
|---|---|---|---|
| Composition | Total | center | Shell |
| % by weight | 100 | 50 | 50 |
| Raw material | | | |
| water (added) | 49.06 | 37.54 | 60.57 |
| liquid sugar | 33.38 | 36.00 | 30.75 |
| glucose syrup | 12.60 | 20.00 | 5.20 |
| gelatin | 1.50 | 3.00 | — |
| orange fruit concentrate | 1.50 | — | 3.00 |
| citric acid monohydrate | 1.25 | 2.50 | — |
| strawberry flavor | 0.25 | 0.50 | — |
| pectin (low methoxy) | 0.22 | 0.43* | — |
| shell stabilizer | 0.18 | — | 0.35 |
| beta-carotene emulsion | 0.05 | — | 0.10 |
| red dye of the elder type | 0.02 | 0.03 | — |
| orange flavor | 0.02 | — | 0.03 |
| Total solids | 36.50 | 45.80 | 27.30 |
| Total water content | 63.50 | 54.20 | 72.70 |

*the 0.43% of pectin (low methoxy) contains 0.03% of calcium lactate. The shell stabilizers contain carob (E 410) and guar (E 412).

1. A method for online preparation of frozen food products comprising a gelled aqueous phase, which comprises the steps of:
A)—preparing a composition A, which comprises the substeps of:
1)—mixing the ingredients, in an aqueous phase, with the exception of the gelling compound(s);
2)—optionally, pasteurizing the mixture obtained in 1);
3)—maintaining the temperature of the mixture obtained in 1) or 2) at a temperature of between −5° C. and +15° C., preferably at +2° C.;
B)—preparing a composition B, obtained by mixing the gelling compound(s) with an aqueous solution optionally containing some of the ingredients at a temperature of between +40° C. and +100° C., preferably between +60° C. and 15+90° C.;
C) mixing said compositions A) and B) at a temperature of between +5° C. and +20° C., preferably between +10° C. and +15° C.;
D)—optionally bringing said food product obtained in step C) into contact with a second iced food product; and
E)—freezing said food product obtained in D).

2. The method as claimed in claim 1, characterized in that said gelling compound is chosen from the group composed of gelatin, pectin, guar, carob and alginates.

3. The method as claimed in claims 1 and 2, characterized in that said food product obtained in step C) comprises gelatin in a proportion ranging from 0.1 to 10%, preferably from 3 to 7%, by weight of said food product obtained in step C).

4. The method as claimed in claims 1 to 3, characterized in that said food product obtained in step C) also comprises pectin in a proportion ranging from 0.1 to 10%, preferably from 3 to 7%, by weight of said food product obtained in step C).

5. The method as claimed in any one of the preceding claims, characterized in that said food product obtained in step C) has a water content of between 30 and 70%, preferably of between 40 and 60%, by weight of said food product obtained in step C).

6. The method as claimed in any one of the preceding claims, characterized in that said preparation A) comprises at least one of the ingredients chosen from the group of sweetening agents, flavoring agents, taste enhancers, stabilizers, preservatives, dyes and fruit concentrates.

7. The method as claimed in claim 6, characterized in that said preservative and said taste enhancer are citric acid, and in that the citric acid is present in said food product obtained in step C) in a proportion ranging from 0.01% to 10%, preferably from 1 to 3%, by weight of said food product obtained in step C).

8. The method as claimed in any one of claims 1 to 7, characterized in that said second frozen food product is an edible shell.

9. The method as claimed in claim 8, characterized in that said method also comprises one or more steps for preparing the edible shell.

10. The method as claimed in any one of the preceding claims, characterized in that said food product obtained in step E) is selected from the group composed of ices and chocolate-flavored confectionery articles.

11. The method as claimed in claim 10, characterized in that said ice is a sorbet.

12. The method as claimed in any one of the preceding claims, characterized in that it also comprises the step of inserting the stick into the food product obtained in step C.

13. A frozen food product which can be obtained using the method as claimed in any one of claims 1 to 12, characterized in that said food product has a soft chewy texture at the temperature for freezing food products.
